(19) United States
(12) Patent Application Publication
(10) Pub. No.: US 2008/0168023 A1
(43) Pub. Date: Jul. 10, 2008

(54) Web surfing enhancer

(76) Inventor: Roy Wayne Stephens, Little Rock, AR (US)

Correspondence Address: Roy Stephens, 17 Longlea Dr., Little Rock, AR, 72212, US

(21) Appl. No.: 11/588,150

(22) Filed: Jan. 8, 2007

(51) Int. Cl. G06F 17/30

(52) U.S. Cl. 707/1; 707/E17.109

(57) ABSTRACT

The invention is a method for collecting web browsing and search data for comparison to other users and to provide customized recommendations back to the registered user. Users will receive suggestions through either their email address or a login process on a web site. While the present process has been shown and described with respect to specific embodiments, it is not thus limited. Numerous modifications, changes and improvements falling within the scope of the process will occur to those skilled in the art.

The process invented is to utilize web search history (either the history file information or otherwise derived data including information in web search engine search boxes) to provide a user with suggested web locations to enhance their experience.

A web site (helpmesurftheweb.com and other sites) will be utilized to register users by their email address. Web search data will automatically be uploaded on regular intervals through a downloaded program. Users' search information will be compared to the data of other similar users, and they will receive either an immediate suggestion for a helpful site, or a regular email weekly listing of customized recommended sites. All personal information is secure and never distributed. The service is provided for free but advertising related to data gathered would be sold and made available to users as an extension of the suggested results.

1. A system for gathering a user's web browsing and search engine information, generally web browser history, into a database with known user identity tags.

2. A system for comparing the data and users of claim 1, thereby generating personalized recommendations to users of additional sites of interest to them.

3. A system of emailing users or allowing login to a web site to view personalized recommendations, together with targeted marketing information and general recommendations to users for additional sites on the internet.

4. A system working with the present and future internet, and mobile or wireless phone and data systems.
